(19) United States
(12) Patent Application Publication
(10) Pub. No.: US 2016/0092918 A1
(43) Pub. Date: Mar. 31, 2016

(54) REAL-TIME ANNOUNCEMENTS AT A GIVEN LOCATION WITHIN A SPECIFIC GEOGRAPHICAL RADIUS

(71) Applicant: Steve CHA, Franklin Lakes, NJ (US)

(72) Inventor: Steve CHA, Franklin Lakes, NJ (US)

(21) Appl. No.: 14/868,995

(22) Filed: Sep. 29, 2015

Related U.S. Application Data
(60) Provisional application No. 62/120,046, filed on Feb. 24, 2015.
(60) Provisional application No. 62/057,603, filed on Sep. 30, 2014.

(51) Int. Cl. G06Q 30/02; G06Q 50/00; H04W 4/02

(52) U.S. Cl. CPC G06Q 30/0251; H04W 4/021; G06Q 50/01; G06Q 30/0259

(57) ABSTRACT

Disclosed herein are an electronic device, method, and non-transitory computer readable medium for finding events or bargains in a map. A request to display specific announcement data within a particular geographical radius is received. In response, a map corresponding to the particular geographical radius is displayed with the announcement data associated with an event or sale currently occurring at a given location within the geographical radius.

### CLAIM OF PRIORITY

This application claims, pursuant to 35 USC 119, priority to, and the benefit of the earlier filing date of, that provisional patent application entitled “Real-Time Announcements at A Given Location Within A Specific Geographical Radius” filed in the U.S. Patent Office on Feb. 24, 2015 and afforded Ser. No. 62/120,046 and the earlier provisional patent application filed in the U.S. Patent Office on Sep. 30, 2014 and afforded Ser. No. 62/057,603, the contents of which are incorporated the reference herein.

### TECHNICAL FIELD

Examples of the present disclosure relate to an electronic device, computer readable medium, and method for providing a community based platform using a map and, more particularly, to a device and method for displaying regional announcements including event, sales, messages, and/or a particular interest of an item or topic to be overlaid over a map within a desired geographical radius.

### BACKGROUND

Electronic devices including portable terminals and desk tops have become widely used in today's society due to the various convenient features they provide and their affordable cost. Countless applications are readily available for download onto these devices for a variety of purposes. For example, a search engine application may permit a user to search for upcoming events or upcoming sales.

As noted above, some applications allow users to search for venues of interests and upcoming events or sales. However, conventional online search engine applications (e.g., Google, Yahoo, etc.) provide users with too many search results/hits. Therefore, users are provided with ample information that is not relevant or regional to their immediate needs which in turn cause countless hours wasted in sifting through the search results. For example, searching for a particular item may show similar items available in a different country. That is, traditional on-line advertisements or search results merely publish information aggregated from a plurality of review sites and search engines. Thus, most users are faced with irrelevant or not material information of their interests.

In addition, search results are typically manipulated by the search engine host based on advertisers' priority status where premium payers would be provided with a higher priority in top search ranking. Thus, the search results are bias to viewers. Moreover, when business venues or establishments advertise through a traditional thirty party ad entity, there is really no assurance that their advertisements or announcements really reach the public or their targeted audiences despite a number of hits reported by the third party ad entity.

Moreover, many businesses may not have the resources to advertise their services or goods using conventional advertising platforms. This is a problem for small businesses who operate with small budgets, and are often faced with a limited set of advertising venues, none of which guarantee direct and straightforward communication of the business offerings to the consumer. Of their available advertising venues, newspaper advertisements allow for creative advertisements at a variety of cost levels, but the potential customer base is invariably limited to those who actually read the particular newspaper, and who happen to spot the advertisement, regardless of their actual need. In an age where copious amounts of information are available on-line, this is hardly an ideal solution.

Public message boards and flyers are inexpensive, but the information is often given to people who do not require it. Hence, most flyers handed out, for example, will likely end up in a garbage bin. Online advertising on blogs and search engines is better than the previous two solutions; however, to guarantee exposure, ever higher advertising costs must be spent, and, as pointed out above, the current strategies for searching do not always return the desired information to the consumer. That is a risk for the small business, as their advertisement may not even be seen by consumers.

Therefore, current marketing or advertising solutions have many drawbacks of not able to connect with consumers or public directly. In addition, currently there is still no direct connection between business entities and consumers in real time because there is no platform to bring these parties network directly.

### SUMMARY

In view of the foregoing, disclosed herein are a method, device, and non-transitory computer readable medium for providing a direct contact between the public and a host which may include business establishments, public entities, individuals, or non-profit entities and venues for displaying announcements of events, specific messages, or sales within a geographical radius of a map. The teachings of the present invention provides online marketing where users can actively post a simple message in real time that is put across the most straightforward fashion which in turn can drive new customers or others to their business or venues. This way, the users can visually review all their options on a single screen and be able to browse the search hits that are location based in a very intuitive manner. As the search hits are displayed over a map with specific messages, the user can visually appreciate the location of desired search hits for planning and avoid conducting another search to obtain a direction to get to the desired location.

In a further aspect, a method may include receiving a request to display specific announcement data within a particular geographical radius; and displaying a map corresponding to the particular geographical radius such that the announcement data associated with a currently occurring event or sale is shown at a given location within the geographical radius.

In yet another example, a non-transitory computer readable medium may have instructions stored therein which upon execution instruct at least one processor to receive a request to display specific announcement data on a map corresponding to a particular geographical radius; and display the map such that the announcement data associated with a currently occurring event or sale is shown at a location within the map at which the event or sale is currently occurring.

In yet another example, a method is disclosed comprising receiving by a processor an input of announcement data or media and a location, the announcement media and the location associated with a user account, associating the announcement media with at least one category of the user account, and transmitting by a network the announcement media and the location to an announcements content server, wherein the announcements content server is configured to receive via the network an announcement request including at least a particular category, a particular location and a designated geographic proximity, and transmit via the network the announcement media when the at least one category matches the particular category and the location is situated within the designated geographic proximity of the particular location.

In yet another example, an electronic device is disclosed comprising, a storage medium, a transceiver to connect to a network, and a processor configured to receive an input of announcement media data and a location, the announcement media and the location associated with a user account, associate the announcement media with at least one category of the user account, and transmit by the transceiver the announcement media and the location to an announcements content server, wherein the announcements content server is configured to receive via the network an announcement request including at least a particular category, a particular location and a designated geographic proximity, and transmit via the network the announcement media when the at least one category matches the particular category and the location is situated within the designated geographic proximity of the particular location.

In yet another example a system is disclosed, comprising a storage unit for storing announcement data or media data, a network interface for communicating over a network, and a processor configured to receive from a publisher terminal or a remote electronic device at least an announcement media and a location, the announcement media and location associated with a user account, associate the received announcement media with at least one pre-associated category of the user account, receive a request from a user terminal for announcements related to at least one specified category, within a geographic proximity of a specified location, and transmitting the announcement media to the user terminal when the at least one specified category matches the pre-associated category, and the location is within the geographic proximity of the specified location.

In yet further aspect, a method may include transmitting a request to display specific announcement data by various users or entities within a particular location; when a user inputs the particular location or nearby thereof as a final destination in a GPS system or application; and displaying a map showing a guide to the final destination corresponding to the particular location such that the announcement data associated with a currently occurring event or sale (or announcement or messages) related to the final destination is shown as a person or driver approaches the final destination.

The techniques disclosed herein may permit a user to receive announcements of events or sales occurring within a radius around the user's location in real-time. The announcements may be positioned at the location in which the associated event or sale is currently taking place. Therefore, the user may easily determine a route toward the location.

The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

FIG. 1 is a schematic diagram illustrating an example electronic network and server in accordance with aspects of the present disclosure;

FIG. 2 is a schematic diagram illustrating an example electronic device in accordance with aspects of the present disclosure;

FIG. 3A is an illustration representing an example display screen for an end-user interface in accordance with aspects of the present disclosure;

FIG. 3B is an illustration representing an example display screen for an end-user interface in accordance with aspects of the present disclosure;

FIG. 3C is an illustration representing an example display screen for an end-user interface in accordance with aspects of the present disclosure;

FIG. 3D is an illustration representing an example display screen for an end-user interface in accordance with aspects of the present disclosure;

FIG. 3E is an illustration representing an example display screen for an end-user interface in accordance with aspects of the present disclosure;

FIG. 4 is an illustration representing an example display screen for an end-user interface in accordance with aspects of the present disclosure;

FIG. 5 is an illustration representing an example display screen for an end-user interface in accordance with aspects of the present disclosure;

FIG. 6 is a flow chart representing an example sequence of steps in accordance with aspects of the present disclosure;

FIG. 7 is a flow chart representing an example sequence of steps in accordance with aspects of the present disclosure;

FIG. 8 is a flow chart representing an example sequence of steps in accordance with aspects of the present disclosure;

FIG. 9 is a flow chart representing an example sequence of steps in accordance with aspects of the present disclosure;

FIG. 10 is a flow chart representing an example sequence of steps in accordance with aspects of the present disclosure; and

FIG. 11 is an illustration representing an example display screen for an end-user interface in accordance with another aspects of the present disclosure.

### DETAILED DESCRIPTION

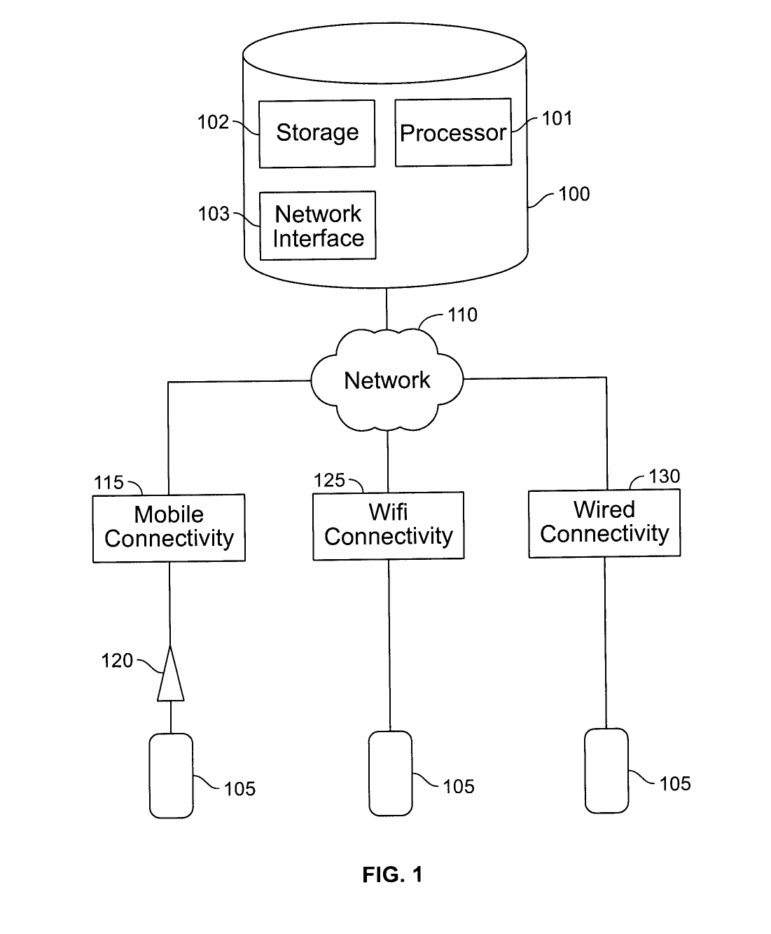

FIG. 1 is a schematic diagram illustrating an example electronic network and server in accordance with aspects of the present disclosure. Referring to FIG. 1, an announcements content server 100 may be provided for receiving, storing and transmitting information related to announcements. Announcements may be, for example, pre-scheduled informational messages that are to be transmitted to requesting users during a set period of time. The messages may therefore convey, for example, advertisements, special promotions, general interests, hobbies, specific needs, job openings, etc. In one example, an announcement may be for a particular promotion at a restaurant, such as a “buy one get one free” deal that lasts from a set time, such as from 5:00 PM to 7:00 PM. Accordingly, the announcement may be transmitted to requesting users at least within the 5:00 PM to 7:00 PM window. These messages may be updated in real-time, meaning that if the “buy one get one free” deal were to be modified at 6:00 PM to further include a free soft drink, then the ad may be updated selectively by the host users in real-time along with the modification to the message.

The announcements content server 100 may be equipped with a processor unit 101, a storage unit 102 and a network interface 103. The processor unit 101 may enable processing and execution of machine instructions. The storage unit 120 may include a program area and a data area (not shown). Further, he storage unit 102 may comprise a variety of different types of computer storage, and generally enable both fast cache-based processing and standard long-term slower access storage. Different types of memory may thus be incorporated into the storage unit 102, which may in reality be several distinct memory modules. The network interface 103 may allow communication over the network 110, and may be also be configured as a number of different units or devices as desired. For example, the network interface 103 may include or incorporate wireless network communication and/or wired network communication using a variety of different technologies, including mobile/cellular networks, wi-fi, Bluetooth, near-field communication, etc. Bluetooth low energy (B.L.E.) fields may be used to access nearby devices that have also queried for the desired information. In the event that the returned B.L.E. results from those devices are more recent that the cached results of the user's current device, the current device's cache will be updated accordingly.

The announcements content server 100 may be in communication with a number of portable or non-portable terminals 105. These terminals 105 may thus represent, for example, a number of electronic devices such as smart phones, personal data assistants, laptop and desktop computers, tablets, phablets, smart wearable devices, televisions and other smart-displays, and any other portable or non-portable electronic device that may beneficially execute the invention described herein. These terminals may be in communication with the announcements content server through the internet 110 through a variety of connections, including at least wired connectivity 130, wireless or “wi-fi” connectivity 125, and mobile connectivity 115, via, for example, a base station and antenna 120 providing a mobile accessible cell. Any means for connecting to the announcements content server may be implemented as required.

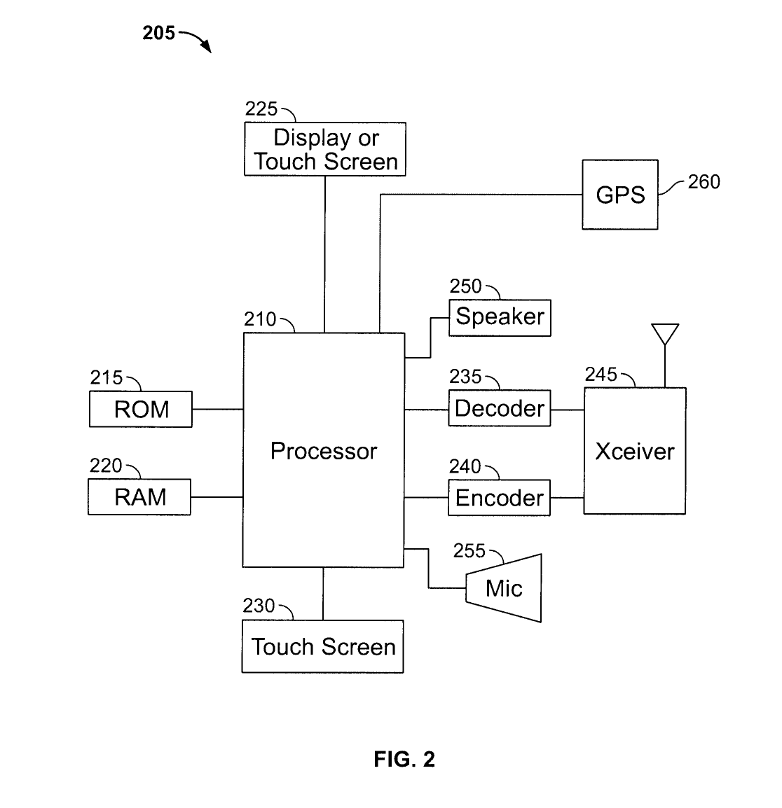

FIG. 2 presents a schematic diagram of an illustrative electronic device 205 for executing the techniques disclosed herein. Electronic device 205 may comprise any of the devices listed above (with reference to terminals 105) capable of processing instructions and transmitting data to and from other devices. Electronic device 100 may include all the components normally used in connection an electronic device, including components not shown in FIG. 2. However, for the purposes of illustration, an example electronic device 205 is shown.

The electronic device 205 may include a processor 210, for executing program instructions, performing calculations and enabling the operation of applications. A read-only memory unit 215 may provide storage space for program instructions and data to be installed on the terminal 205 by the manufacturer. For example, an operating system or other fundamental operations (and attendant requisite data) may be stored on the read-only memory unit 215. A random-access memory unit 220 may also be provided for enabling storage of user-selected programs, such as full-fledged applications, “apps” from a mobile store, user media data (such as pictures, movies, and music), and other assorted data.

A display 225 may be provided for interfacing with the user. The display may be configured to display operation data to the user for interaction with the electronic terminal 205. The display may be a conventional monitor for more traditional computing solutions, such as a desktop computer or a laptop computer. For more mobile solutions, the display may be an “LCD,” “LED,” “OLED” or “AMOLED” display with an integrated touch-screen, which may operate as, for example, a capacitive, resistive, acoustic, infrared, optical or dispersive signal touch-screen. The touch-screen may thus be utilized to receive a variety of input information from the user as the input 230, such as an on-screen keypad utilized for inputting text. In non-touch-screen enabled devices, input 230 may function as, for example, a physical keypad or keyboard, a mouse, a stylus, or some other combination of like devices. Similarly, touch-screen devices may also include physical keypads and other input buttons for inputting data in tangent with the touch-screen.

A decoder 235 and encoder 240 may be provided in the electronic device 205 to provide decoding and encoding functionality to information transmitted and received by the electronic device via the transceiver 245. The transceiver 245 may in turn be utilized to communicate with external networks or devices, and may thus represent a plurality of communication technologies, including, for example, a Bluetooth unit, a wi-fi unit, a cellular communication unit, a near-field communication unit, a universal serial bus unit, a micro universal serial bus unit, etc. The electronic device 205 may thus include as many of these communication technology units as desirable and/or feasible. It is noted that while represented as a single unit here, the transceiver 245 may in reality be one or more disparate units.

A speaker 250 may be provided for outputting sound. Similarly, a microphone 255 may be provided for the input of sound. This may enable, for example, cellular calls (if the electronic device 205) is a smartphone, in addition to other functions, such executing video calls, recording sounds or playing back media data.

A global positioning system unit 260 may aid in locating the terminal 205 when a user or application requests the current location of the terminal 205. This may be beneficial for detecting the area in which announcements should be returned to the user terminal 205.

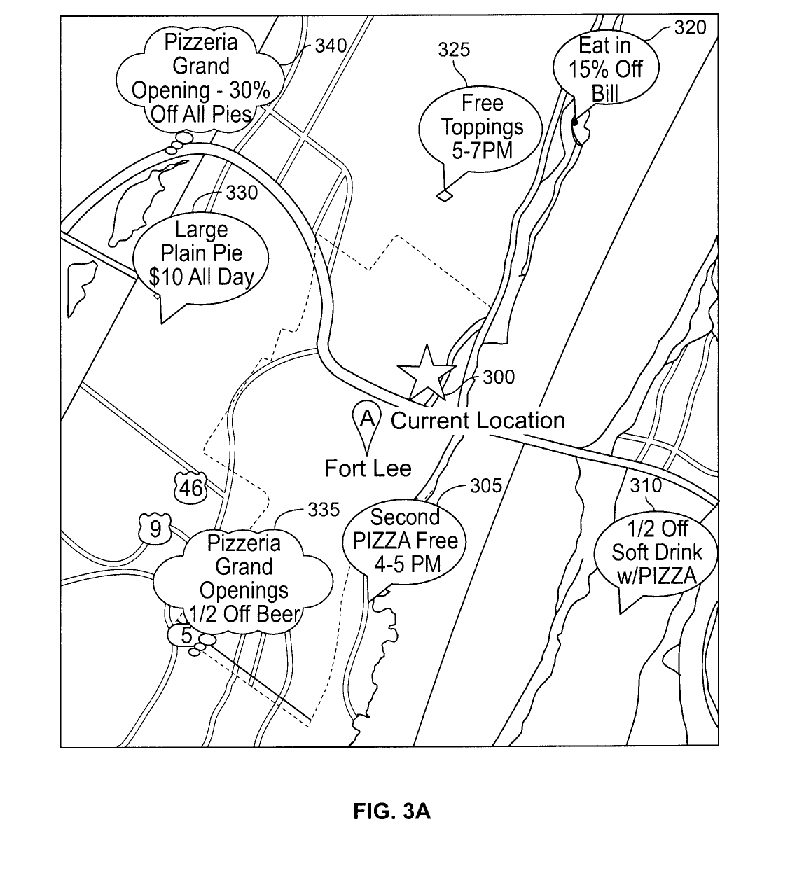

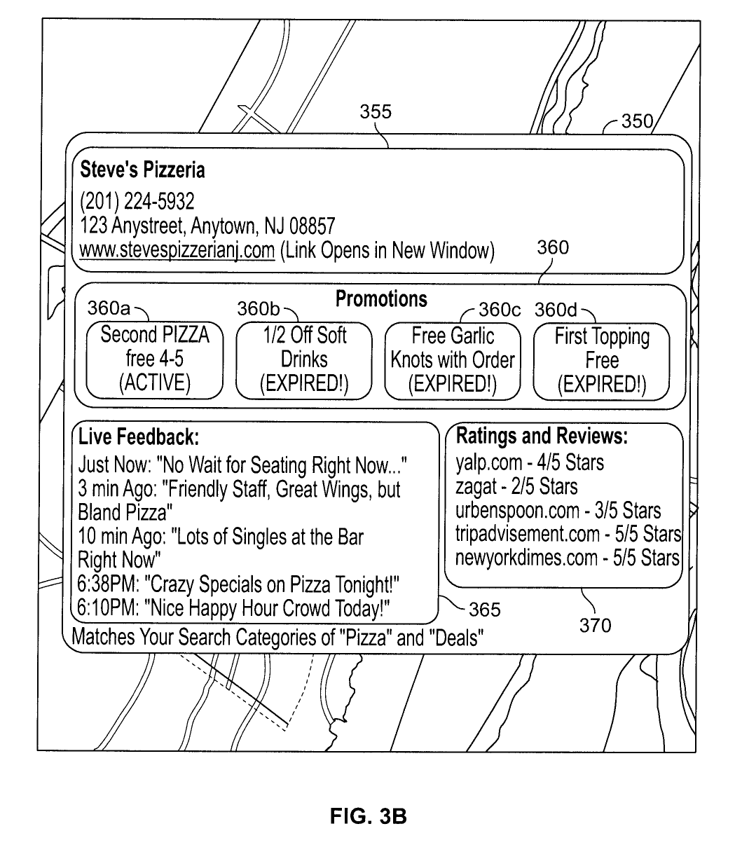

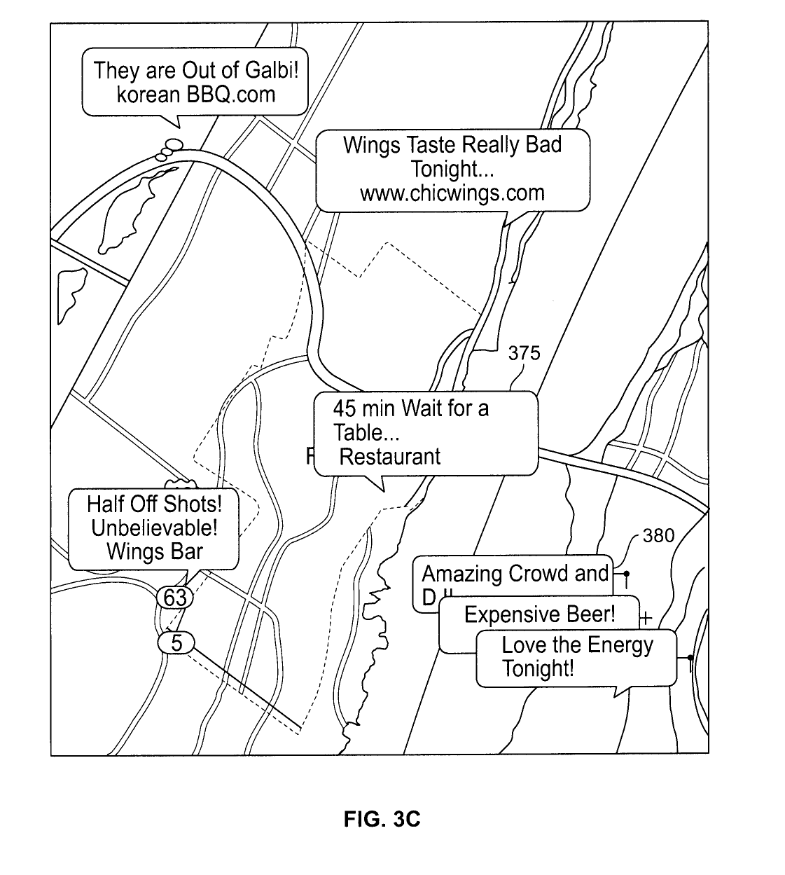

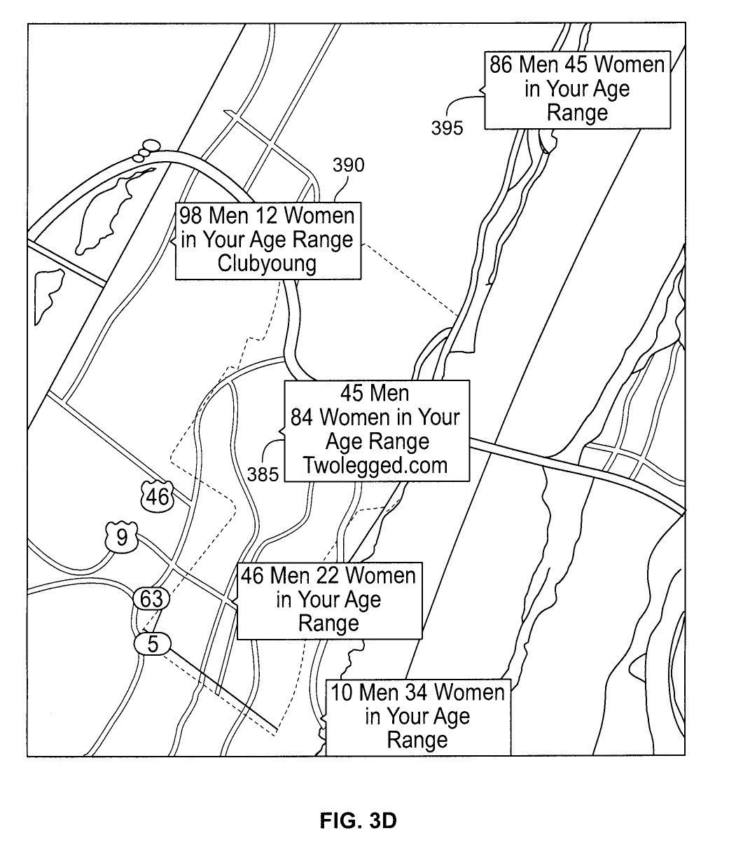

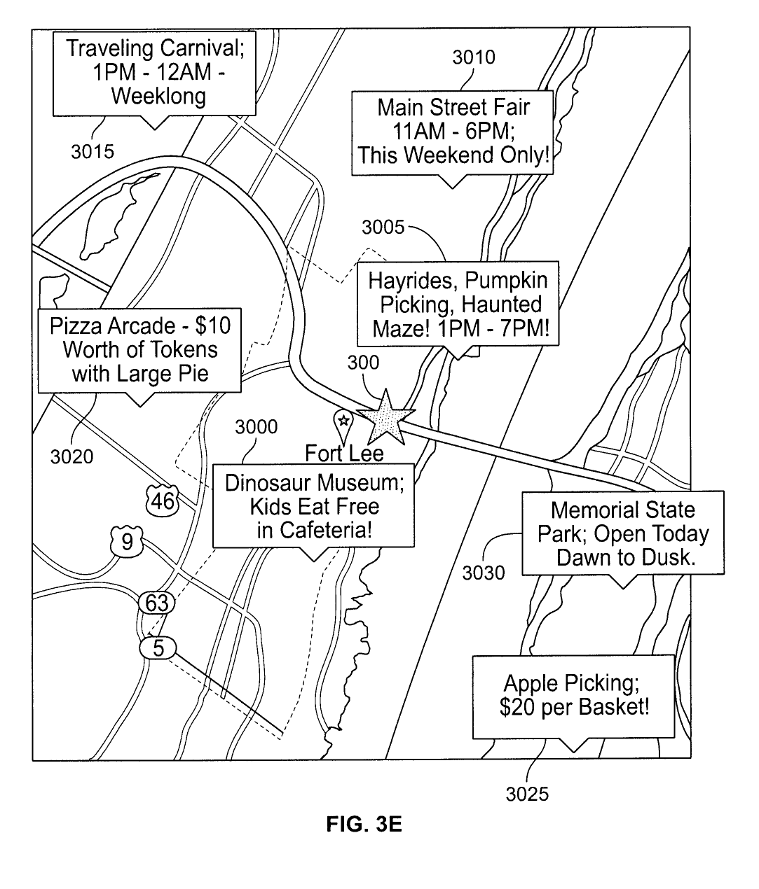

FIG. 3A is an illustration representing an example display screen for an end-user interface in accordance with some aspects of the present disclosure. Advantageously, the above-described electronic device, method, and non-transitory computer-readable medium allow users to connect directly with proprietors, merchants, event hosts, etc. through the use of an online map. Thus, an end user may, for example, view announcements of events or sales within a desired geographical radius around the end user's current location. Because the announcements are displayed in response to user requests for certain types of information, via a selection of one or more categories, announcements will more likely reach users that are searching for the particular type of announcement, relative to conventional forms of advertisements. An example of this may be shown in FIG. 3A.

In FIG. 3A, a user has requested information on certain announcements situated within a given geographic proximity, i.e., 5 miles, of a current location 300, which may represent the user's current location based on, for example, GPS-enabled locating of the user terminal, as described above. Announcements relevant to the user request may thus be displayed on the screen if they are within the designated physical proximity to the user's current location 300. It is understood however that the user may also specify their location by, for example, entering a current address or GPS coordinate. In the event that an internet request cannot return a result, cached data from previous searches would return the most recent search results. (It is understood that these cached search results contain a self destructing timer mechanism to denote the expiration of an event/promotion. In the event that a cached result must be used, the cached result time stamp will be compared to the native mobile device clock, and, if the time stamp time exceeds the time allotted, that the event may not be displayed. The event may also display a message indicating that the time for the promotion has expired) It is further noted that the user may enter a different location than their actual location. This may be beneficial if, for example, the user wishes to receive announcements related to promotions for stores near a destination they will be traveling to later. Promotions may be searched for by inputting an address directly, or by searching for a city in list styled selection. In the event that a user asks for information relevant to an entire city, the map display zoom would be calibrated to fit within the bounds of the entire city. Information for all of the events in the city would not be displayed in this situation, as the screen may become too crowded to fit all of the information callouts. Instead, only information that most directly matches the search request will be displayed. In the event that there is still not enough screen real estate available, the results would become further filtered by expiration date. A client/business owner may promote their advertisement for a certain fee—this would allow the client to make sure that their results are displayed (even if the event does not expire in the near future).

Returning now to FIG. 3A, in one embodiment of the invention, only announcements relevant to the user's request may be displayed. For illustration, in the example of FIG. 3A, the user has requested information relating to at least two categories of announcements, these being “pizza” and/or “deals” (or “promotions,” “sales,” etc.). Accordingly, only announcements that have been pre-associated with “pizza” and/or “deals” are returned to the user.

Furthermore, the announcements content server preferably also returns announcements that are currently in effect. For example, announcement 305 reads “second pizza free 4-5” indicating that the deal is in effect from 4:00 PM until 5:00 PM. Accordingly, the announcement may be displayed at least from 4:00 PM to 5:00 PM. In some embodiments, this may be displayed some quantity of time before 4:00 PM. For example, this may be set to display one hour before activating, so that viewers have a chance to see it before the deal goes into effect. This may allow users to begin arriving for the deal at 4:00 PM, which would be impossible if the announcement only began broadcasting at 4:00 PM. In any event, unless the deal is extended after the initial expiration time, the deal preferably stops broadcasting at 5:00 PM, avoiding confusing users by display of both active and non-active deals.

Furthermore, the server may also return results for future revisions to the promotional model. In other words, when a user requests information from the sever, the returned result will also include future event callout information. This becomes useful because the business owner can create business models for different times of day, without having to wait for that time of day to occur. For example, if a restaurant owner knows that he/she will have a drink special between 4:00 p.m. and 5:00 p.m., and a dinner special between 5:00 p.m. and 6:00 p.m., the owner may, on his/her own client administrator page, post these pieces of information at the same time. This becomes a big convenience for the client/administrator, as he/she may plan out their event promotions ahead of time. Additionally, this provides a better experience for the user because the map will update the event information automatically when the time comes. In the stated example, assuming that the client./administrator has posted both event deals in the administration page, when the time reaches 5:00 p.m., an animation will occur to change the notification from “Drink Special” to “Dinner special.” No new data will be needed to be fetched from the network; instead, that data was already made available from the previous request. The record of the expired “Drink Special” event will become automatically evicted from the device's local cache at this point. Because no new network fetches will occur in this scenario, the user will still be able to see relevant information, even when their device is offline. Additionally, the user may see information as soon as the time for the new promotion becomes available.

Event administrators may also calibrate event promotions in such a way as to repeat repeat the promotion for certain times of day or for certain days of the week. Is he/she so chooses to do this, then the event promotional information will neither be stored nor evicted from the cache; instead this information will contain a tag indicating that the information will only be displayed via network fetch. Caching technologies will not be allowed for this kind of information.

Returning to the illustration of FIG. 3A, a number of such active promotions (or soon-to-be-active promotions, as described above) may be displayed in proximity to the current location 300. As disclosed above, these promotion announcements 305-340 may be displayed because they match the user's search categories of “pizza” and/or “deals” (based on their own associations with these categories), and further, because their geographic location falls within the designated proximity of the current location 300. Additionally, the announcement 305-340 are preferably displayed indicating the relevant location wherein the promotion, event or deal may be purchased, activated, acquired, etc.

When a user has selected one of the announcements 305-340, the user may select (via, for example, a “click” or a “tap” or some other relevant input) the desired announcement. The desired announcement may then expand to a larger window, display a pop-up window, display a drop-down window, or generally display additional information relating to the selected announcement in some appropriate format. In one example, the selected announcement may expand and display the address of the offering establishment. Therefore, if the user were to execute a “tap” input on announcement 305, the announcement 305 would expand to display more information, including the address of the pizzeria offering the promotion. It is understood that in other embodiments, the announcement may expand to display other relevant information, such as media related to the deal, contact information such as images, e-mail or telephone number, or a link to the establishment's website. This page may be considered to be the “event page”, as it will contain all of the relevant information related to the event. On this event page, there may be a button to select with a title “going to attend” or something along those lines. If this button is tapped, a network request will fire, with the instruction to associate the event with a user. As an example, this can be performed via a join table function if the backend is managed with SQL languages. The reason why a user may tap this button is because once this request is made, information about other users that are going to the event will be returned in the return fetch. Thus, if the user signs up for the app via a social media service, such as Facebook or Twitter, then on the event page, information about other users who have also decided to press the “plan on attending” button may become available.

The announcements may be displayed utilizing a variety of different shapes, colors, or media depending on a desired effect or organizational scheme. For example, in FIG. 3A, announcements 305-330 are displayed utilizing a “word bubble” shape, which may signify (in this example) that the deals displayed are standard one-time promotions. If a user selects one of the announcements, a new page can be displayed on the whole or part of the screen to list a detailed information associated with the selected announcement. In contrast, deals 335 and 340 utilizing a “thought bubble” shape. In this example, these may indicate to a user that these are promotions associated with a grand-opening event for the restaurant in question. It is understood, of course, that other shapes may be used to signify this information. Further, it is understood that any shape may be utilized to signify any desired information to be conveyed to the user via a shape. It should be noted that colors may also be used to indicate information to the user. Alternatively, shape and color, alone or in combination may be used to indicate different information type to the user.

For example, although not shown in FIG. 3A, different colors may indicate, for example, different types of events or promotions. For example, a blue color may indicate that the deal is a one-time promotion. A red color may indicate a deal associated with a grand opening of a pizzeria. Again, any color may be used to indicate any information to be conveyed to the user via the color. Further, the color may be applied to a shape or a font of a message to be displayed to the user. Multiple colors may be used in conjunction to create patterns indicating said information to a user. In an alternate embodiment, if a number of event announcements that can be displayed in a single screen is too large to interfere and/or overlap with other announcements, different color scheme can be used to hight light the different levels of message or announcement types without the actual text messages, then a user can further select the desired event or announcement on the screen to obtain further information which can be displayed in a new screen or on a portion of the currently displayed screen.

Besides shapes and colors, media may also be utilized to indicate information to the user. Banners, logos, movies, pictures, sounds or music may be used to differentiate between different types of events, promotions or deals. The media may be displayed within, for example, a particular shape. Alternatively, the shape may be selected and a larger window displayed, wherein a more involved form of media (such as a movie with sound) may be played advertising the relevant deal, package, event, etc.

Sounds may also be used to convey desired information to a user. For example, a “chime” sound may be played whenever a user selects or touches an announcement related to a one-time promotion. A “bell” sound may be played whenever a user selects or touches an announcement related to a grand-opening promotion. It is understood that any sound or set of sounds may be utilized to convey the desired information to the user, and this disclosure should not be limited to the explicit recitations made herein.

Furthermore, in some embodiments of the invention, these announcements displayed may be updated in real-time. That is, if a proprietor of the pizzeria offering the “second PIZZA free 4-5” promotion announcement 305 decides to spontaneously extend the promotion to 6:00 PM, then the proprietor may, through an interface (described later below), edit the promotion to read, for example, “second PIZZA free 4-SPM—now extended to 6 PM!” Accordingly, a user browsing for pizza promotions may see the message in announcement 305 updated in real-time. If a user has indicated that he/she will be attending the event, and some of the event information has changed, then a push notification may be sent to the user to communicate this changed information.

Updates may be accompanied by visual, audio or tactile cues indicating to a user that an update has occurred. For example, a “chime” sound, color-change or vibrational haptic broadcast from the user's terminal may indicate to the user that a promotion announcement being displayed has just been changed. Additionally, visual, audio or tactile cues may indicate to a user that a promotion announcement has changed since the last viewing, if the user has not been viewing the map screen of FIG. 3, and has just reopened the map.

An end user viewing the map may select the announcement 305 because they are interested in learning more about the promotion or restaurant. In response to the selection, the screen of FIG. 3B may thus be displayed. In FIG. 3B, the announcement 305 may enlarge into or be displaced by the information pane 350. In the information pane 350, a general information field 355 may display information about the location, venue, event or promotion. In the present example, the general information field 355 displays the name of the restaurant, the telephone number, the address, and a website link. It is understood that other information may be added or removed from the general information field 355 as desired.

The information pane 350 further displays a promotion pane 360 that shows at least a current promotion 360a. In the present example, the promotion pane 360 further shows expired promotions 360b-360d, referring to promotions that were previously active but are now no longer valid. It is understood, of course, that a restaurant may operate, for example, multiple promotions at one time, and as such, the promotion pane 360 may also be configured to display multiple active promotions at any given time.

A live feedback pane 365 may also be displayed, allowing an end user to view feedback on the establishment left by other users in real-time. This feedback would be created via a link on the event page. The live feedback pane 365 presents different information to an end user compared to a traditional review. Whereas a traditional review is static and locked into the moment in which the reviewer actually visited the restaurant, the live feedback pane 365 may offer feedback on the state of the establishment at the present time. This allows it to convey vastly differently information. While basic reviews of the food and service may be included, it can also update end users on, for example, the current wait-time for the restaurant, the present atmosphere and crowd of patrons, whether a particular favored chef is cooking that night, and comments on the current sales and promotions. Users may be allowed to leave any such feedback. Moderators may also be provided to prevent inappropriate comments or language across feedback issued through the announcements content server. Each time the event information page is visited, a network request will be fired (if possible) to search for new datum. Emails may be sent to event administrators indicating what people may be saying regarding their promoted event. This information may also be displayed on their own administrative panel on their web page.

A rating and reviews pane 370 may display to the end user general reviews written about the establishment from a plurality of online sources. As these reviews are aggregated in one space, they may allow the end user to quickly grasp the general quality of the establishment over the period in which it was reviewed.

It is understood that the general information pane 350 may take other forms and formats, and include other organizations and presentations for the information displayed. The general information pane 350 may be customizable to accommodate the category of announcement being displayed, and the example given herein is tailored to the particular example of an eating establishment, to which the invention is by no means limited.

FIG. 3C illustrates another example embodiment of displaying announcements on a map screen. In FIG. 3C, an end user has requested display of announcements related to other end user comments on local restaurants. For example, the end user may have selected categories of “bars,” “social” or “live feedback.” Accordingly, the announcements content server may return announcements related to the selected categories, which may include “live feedback” for “bars” generated by other end users at the restaurants for “social” gatherings. End users at these other restaurants may use the announcement content server to broadcast impressions, real-time reviews and current statuses of the establishments. Accordingly, an end user who is annoyed at waiting for a table may post a live feedback announcement 375 stating “45 min for a table . . . ” The live feedback message 375 may then be displayed or otherwise indicated near the actual location of the establishment on the map. If this announcement is tapped, then a full table of comments/posts about the event may become available. On Android, this would be displayed in a tablelist format; and on iOS it would be displayed via a UITableView. The tables would be show all of the different comments about the event (create figure here). It is also possible that the event annotation may have upvote and downvote functionality (create figure). At this point, the event administrator would have been contacted via some means from our server indicating that there is a negative reception. When multiple users are commenting on a single establishment, a variety of strategies may be used so that the information does not overcrowd the display of the map. In one embodiment, shown in the feedback stack 380, the live feedback messages may be stacked or tiled on top of one another, so that the end user recognizes that the multiple live feedback messages all reference a single establishment or location. The end user may input a selection of a particular message to display, which upon the selection moves to the front of the feedback stack 380 allowing the end user to read the displayed message. It is understood that other visual arrangements may be utilized as desired, such as drop-down and pop-up menus. For example, a radial circle of feedback messages may be displayed centered on the location. Alternatively, messages may disappear upon being read, and a new unread message may occupy the vacated space. Any appropriate strategy may be utilized as required.

FIG. 3D illustrates another example embodiment of displaying announcements on a map screen. In FIG. 3D, “passive” announcements are displayed on the map. A passive announcement may be based on aggregation of user data that has been allowed to be published, but has not specifically been requested for publication as an announcement. The example of FIG. 3D will illustrate. In the example, end users may allow their terminals to report a present location and a user's age to the announcements content server. This may be done via a privacy setting on the user terminal, which may allow users to customize which aspects of their personal information and category preferences are shared.

In the present example of FIG. 3D, some end users have chosen to share their sex, age and present location with the announcements content server. Accordingly, a single end user hoping to form connections with singles of a particular sex may request from the announcements content server passive announcements related to, for example, categories of “singles,” “meet-ups,” “guy girl ratio,” etc. Accordingly, the announcements content server may return one or more passive announcements related to the selected categories. For example, for the category “guy girl ratio,” the announcements content server may automatically generate a ratio of men to women utilizing the reported locations for users having an age range falling within the end user's indicated preferences. Therefore, the announcements content server may select, for example, five locations corresponding to “singles” or “meet-ups,” as indicated on FIG. 3D. Then, for end-user information having a location matching one of those five locations, the announcements content server may tally the total number of reported men and reported women at each location matching the user's desired age range.

The tallied information may then be presented to the end user, as shown in FIG. 3D. A location indicated by the announcement 385 may report the presence of 45 men and 84 women in the indicated age range. A location indicated by the announcement 390 may report the presence of 98 men and 12 women in the indicated age range. A location indicated by the announcement 395 may report the presence of 86 men and 45 women in the indicated age range. The end user may thus select a location most likely to facilitate the interactions he or she desires.

As with the previous embodiments, selecting one of the announcements 385-395 may cause the display of additional information about the venue, or the end users situated there, as described above. Additional information may be provided that is relevant to the interaction that is being facilitated. For example, if users share their personal interests on the announcements content server, the announcements content server may display to the end user that a certain number of end users at the location share the similar interests. This information may also be extracted via a Facebook open graph search, if the user does decide to login via Facebook, and grant the app those permissions. Interests may also be automatically learned or determined from the end users' respective search histories as stored on the announcements content server.

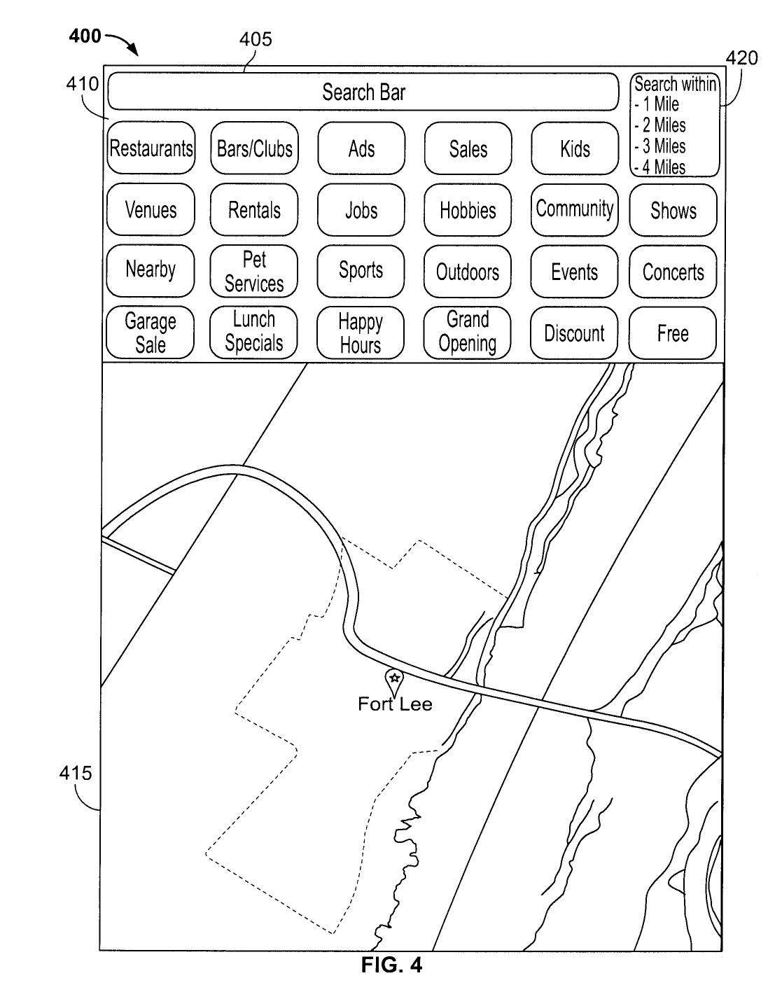

FIG. 3E shows another example embodiment of displaying announcements on a map screen. In FIG. 3E, “Kids” announcements which relate to all the entertainment activities associate with children within a given radius of the user location 300 are displayed on the map. As a result, parents can view all their options (3000, 3005, 3010, 3015, 3020, 3025 and 3030) of entertaining their children within their home town at a given day or time. Similarly, a user can search all the garage sales occurring nearby their home town in a similar fashion so that user can visually see all their options. Host of garage sales can directly post their messages indicating the time and date when they are having the garage sales. A user can also search for all part time jobs available in a given downtown close to their home or look for any one time job available in a weekend, such as a snow removal. As a result, the present invention provides an easy way for the host to advertise their announcements directly using their personal computer or a mobile device, thus eliminating the needs to make flyers and advertise in a local newspaper, and provides bargain hunters to obtain all the necessary information on a single screen and plan their day more efficiently using the visual messages being posted on their devices. Therefore, the teachings of the present invention can expand to other scenarios where the users can directly post messages and the viewers can visually obtain all their desired search outcome within their desired location, thus eliminating the need for a third party agent for advertisement. In an alternate embodiment, a user can further select a calendar feature that may be tapped on the event page, as shown in FIG. 3. This calendar serves the purpose of displaying any future occurrences of this event in a calendar format.
FIG. 4 is an illustration representing an example display screen for an end-user interface 400 in accordance with aspects of the present disclosure. FIG. 4 represents a search interface for a user. When a user wants to discover announcements related to events, promotions, deals, etc., the user may utilize an interface such as the one illustrated in FIG. 4. The end-user interface may be implemented and executed on the user's local terminal, including portable terminals (such as smartphones), and non-portable terminals (such as desktop computers). In an alternate embodiment, a user can select a calendar feature that may be tapped on the event page. This calendar serves the purpose of displaying any future occurrences of this event in a calendar format.

First, a search bar 405 may be provided in the end-user interface 400 for receival of search keywords. In an alternate embodiment, the users can input voice commands to search for desired items or venues. For example, to obtain announcements related to pizza promotions, the user may enter search keywords such as “pizza,” “pizzeria,” “deals,” “specials,” “promotions,” etc. in the search bar 405. Entry of the text may cause the end-user interface 400 to transmit the entered search keywords to the announcements content server, which may then return announcements related to or matching the search keywords for announcements that are in the relevant geographical proximity to the user's current location, or a user-designated location. These may then be displayed on the map 415 (as illustrated, for example, in the example of FIG. 3).

The end-user interface 400 may also include a search proximity dialogue 420. The search proximity dialogue 420 may allow a user to customize the search area shown in the request map 415 with a desired scope. For example, if the user selects a larger search proximity such as “10 miles,” the map may be zoomed out so as to show at least a 10 mile radius around the user's current location or the user designated location. It is understood of course that the display area is not limited to the 10 mile radius, since the example map display 415 displays a square or rectangular area. However, it should be understood any appropriate display stratagem may be utilized as required. FIG. 4 may also have an option for a “default” search option—this option would create a search and return a specific number of results within the radius. An example of a search with an optimized radius would be one with only 5 to 10 results that may appear. So, the search radius would be specified such that 5-10 results will appear on screen.

The end-user interface 400 may also include a category section 410 displaying, for example, some categories that may be of more relevance to the user. The user may simply select the desired categories from the category section 410. For example, the category section 410 may display categories that are most frequently searched for by the user. Alternatively, the category section 410 may display the most recently searched for categories in the user's search history. In yet another example, the category section 410 may display categories the user has indicated for display here. These implementations (and combinations of these implementations) may be provided for the benefit of the user. It is understood that category section 410 may display any arrangement of categories desired by an end-user, and is not limited to the examples cited herein. Selection of one or more of the categories may cause the end-user interface 400 to transmit the selected one or more categories to the announcements content server, which may, in response, transmit back to the end-user interface announcements related to the selected one or more categories and situated within the appropriate geographical proximity to the user's location or the user-designated location, for display on the map 415.

FIG. 5 is an illustration representing an example display screen for a publisher user interface 500 in accordance with aspects of the present disclosure. The publisher user interface 500 may be provided for a publishing user who seeks to publish an announcement out to a larger body of users (although, as will be seen, provisions may be made to allow the publishing user to retrieve desired announcements for him or herself on this screen as well).

An announcement editing field 505 may be provided for entering an announcement to be published. In the example of FIG. 5, announcements adhere to a text-based format, and the publishing user has entered in a special promotion to be published, including the text “Buy two large pies and get the third free! . . . Free delivery to 10 PM.” The announcement editing field 505 may be configured, in this or in other embodiments, to accept other formats of announcements. For example, if media is to be used in an announcement, the announcement editing field 505 may include functionality enabling a publisher user to upload the relevant media to the announcement. Similarly, if the media is to be displayed only when, for example, an end user selects a function, such as selecting an announcement to view more details regarding it (as described earlier with reference to FIG. 3), the announcement editing field 505 may preferably include controls enabling a publisher user to set that option as well.

The announcement editing field 505 may be complemented by an announcement duration field 510. The announcement duration field 510 allows a publisher user to set a time variable for the publication of the announcement. Time variables may include, for example, a start time and end time, a day, a week, a month, or a year of the promotion. The time variables may in some embodiments further include a desired time before the start of the promotion to broadcast the promotion (which may give customers advance notice of the promotion).

In one embodiment of the invention, the announcement duration field 510 may further include access to a visual graphic calendar. The calendar may be displayed within the visual space allocated to the announcement duration field 510, or it may be expanded to display over other visual elements of the publisher user interface 500. The calendar may be adjusted to display time periods over a year, a month, a week or a day. Other such levels of granularity may be implemented as desired. Within the calendar, the publisher users may specify, using associated tools and functions within the calendar, the desired time period that the announcement is to be published and when it should expire. The publisher users may also be able to view other scheduled announcements associated with their account in the calendar.

Further, the announcement editing field 505 may be complemented by a location editing field 515. The location editing field 505 may allow a publisher user to designate where the promotion of the announcement may be accessed, secured, purchased, acquired, etc. For example, if the announcement is a special sale at a pizzeria (as in FIG. 3), then the location editing field 505 may allow the publisher user to designate the address of the pizzeria. As shown in FIG. 5, the announcement editing field 505 may also allow the publisher user to select a location if one or more locations have been previously entered into the end-user interface 500. Accordingly, the publisher user in the present example of FIG. 5 may select “location A,” “location B,” or “current Mobile GPS.” The location editing field 505 may be configured to allow the user to select the address manually from a map, by way of a pop-up menu, a drop-down menu, display of a map screen, or an expansion of the location editing field 505 to display a map.

The publisher user's profile information may be shown in a profile 520. The profile 520 may include basic information for registration of the publisher user, such as the profile account name (e.g., “Steve”), the business's name (e.g., “Steve's Pizzeria”), the telephone number (“201 224 5932”), the address (e.g., “123 Anystreet, Anytown, N.J. 08857”), etc. It is understood that the profile information may include more or less information, as required. It should be further understood that either more or less of the information may be displayed at once. If less of the information is displayed, the undisplayed information may be displayed via selection of a dialogue option, such as a scroll action, expansion of a window, or display of a new screen.

An associated category field 530 may be displayed showing the categories that the publisher user's establishment is associated with. In the present example of “Steve's Pizzeria,” it may be seen that the pizzeria is associated with the categories of “pizza, bar, sports bar, wings, beer, alcohol, late night, casual dining, social, weekend, restaurant, Italian, pasta, hang outs, delivery, carry out, sales, promotions and deals.” Accordingly, announcements posted under this account may be automatically associated with some or all of these categories, as desired by the publisher user. An end-user searching for “wings” or “late night” may thus discover the announcement published from this account, due to the association of the account with the categories of “wings” and “late night.” The publisher user may add or remove categories from association with the account using the associated category field 530.

Additionally, the publisher user may also associate categories with particular announcements. For example, if the publisher user wishes to run a special on ice-cream during the summer, but does not normally serve ice-cream, “ice cream” may not be a category associated with the account. Rather than associating “ice cream” with the account only for the particular special, the publisher user may instead associate the specific announcement for the sale of the ice cream with the category of “ice cream.” Therefore, the publisher user will not have the account erroneously associated with “ice cream,” and the announcement for the sale of the ice cream will appear when end users search for the category “ice cream.”

A live feedback field 535 may present to the publisher user reviews and comments left by other end users for the particular establishment or announcement in real time. Accordingly, each comment or review may be associated with a time-stamp, indicating to the publisher user and to other end users when the comment was made. End users may thus appraise each other of the current status of the establishment, in addition to leaving their opinions and thoughts on the service or food presented at the establishment. For example, an end user may leave the message that there is “No wait for seating right now . . . ” beneficially indicating there is no wait-time for seating at the establishment. Another end user may leave the message “Lots of singles at the bar tonight,” indicating to other end users that there is a good opportunity to mingle. This real-time feedback information may thus provide different information that is highly desirable, but unavailable or inappropriate for a traditional “review” format, which rarely or never reflects the actual present state of the establishment.

Finally, it is contemplated that the publisher user may also desire to discover announcements relevant to his or her own interests. In one embodiment, a categories field 540 and sub-categories field 545 may allow him or her to do so without leaving the publisher user interface 500. It is noted that in other embodiments, the publisher user may simply switch to the standard end user interface 400 of FIG. 4. As with the category section 410 of FIG. 4, the categories field 540 may also include a number of categories most frequently searched for, searched for most recently, or specifically designated by the publisher user. The publisher user thus may customize the categories field 540 according to his or her preferences.

Selection of the categories field 540 may, in some embodiments, cause the display of a sub-categories field 545 to allow selection of “sub-categories” related to the primary category that has been selected. It is understood the sub-category field 545 is not limited to the embodiment of FIG. 5, but may also be applied to other embodiments of the present invention, such as the embodiment of FIG. 4. In the present example, the “personals” category has been selected in the categories field 540. As a result, a “personals” sub-category field 545 has been displayed, allowing the publisher user to designate more options to limit the search results. For example, the publisher user may select a desired age range, sex, proximity and filter results for only those including a text description and a picture. Accordingly, the announcements content server may reply with only announcements for the category of “personals” matching the sub-categories designated therein.

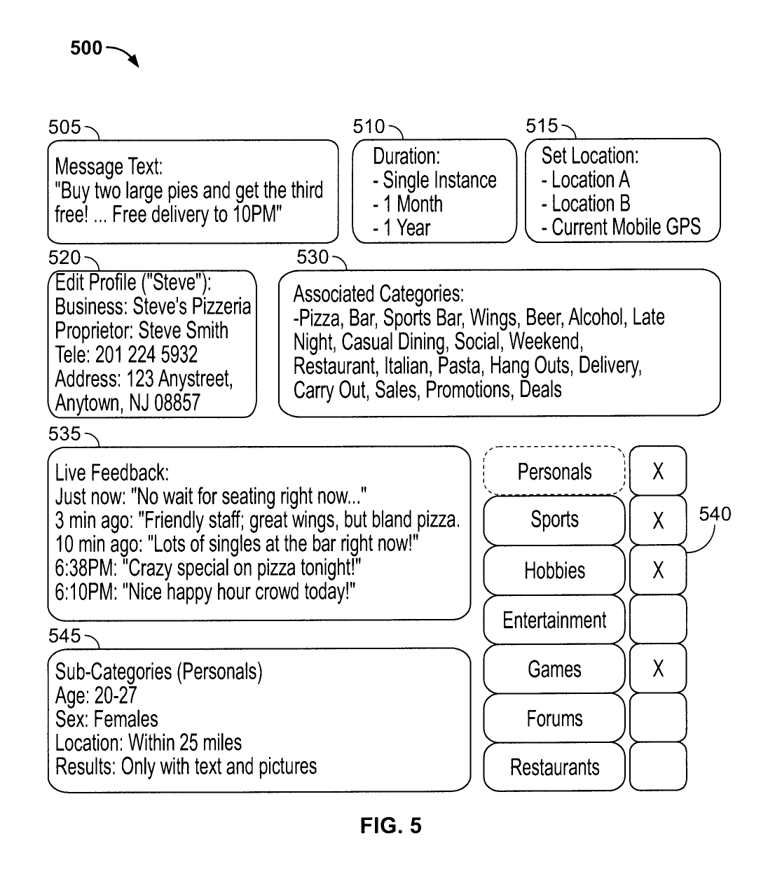

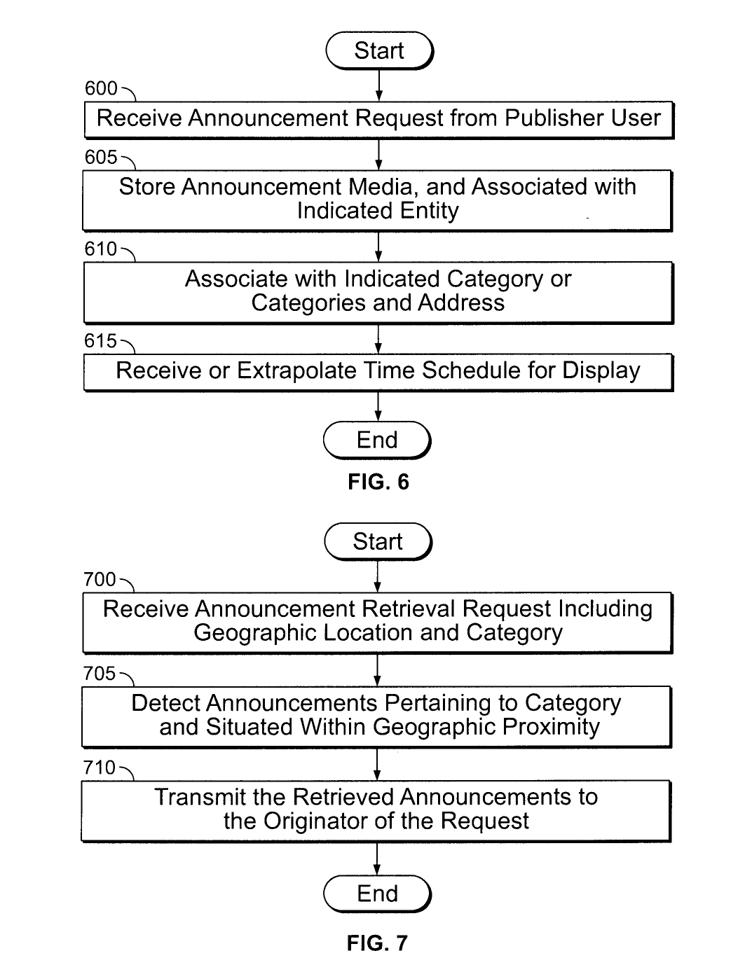

FIG. 6 is a flow chart illustrating the creation of a new announcement by a publisher user or a host. In step 600, the announcements content server may receive a request to generate a new announcement (via, for example, a publisher user generating one within the publisher user interface of FIG. 5). The request may be accompanied by, for example, an announcement text entered into the publisher terminal utilizing, for example, an on-screen keypad or a physical keypad or keyboard. The request may include one or more of special category associations, text, media (such as imagery, movies or music and sound), custom address, etc., and associate the announcement with the account of the publisher user from whom the announcement was received.

In step 610, categories are associated with the announcement based on the account of the publisher user and also with any special category associations received with the request. Similarly, an address is associated with the announcement. The address may be one or more of the addresses associated with the account of the publisher user. For example, if the publisher user owns a number of restaurants who are all offering the promotion, the publisher user may indicate that all associated restaurant addresses in the account are to be associated with the announcement. In another embodiment, the publisher user may specify only a single address to be associated with the announcement, or the publisher user may designate a custom address not associated with any of his establishments.

In step 615, the schedule for publication of the announcement may be received or extrapolated from the request. As described above, the publisher user may indicate the time period for which the announcement is valid, thereby setting, for example, a duration in which the sales promotion is operative. The time period may further include a period of time before the activation of the sales promotion, so that later, during publication, end users will be able to anticipate the start of the sales promotion. This time information may thus be stored for the announcement.

FIG. 7 is a flow chart illustrating how the announcements content server responds to requests for announcements. In step 700, the announcements content server may receive a request transmitted from an end user searching for relevant announcements. The request may include at least a geographic location of the end user and a category. For example, the geographic location may be a present location of the end user's terminal, or a location designated by the end user. The category may correspond to the particular kind of announcement the end user is searching for.

In some embodiments, the category may be received as a search keyword that does not correspond exactly to a list of registered categories on the announcements content server. In these cases, the announcements content server may conduct a search to detect the registered categories that most closely match the received category. For example, a typo in the typing of the category from the end user may be identifiable to the list of registered categories if only one or two letters are out of place. Similarly, because words are typically heavily related to other words, these relationships may be utilized to detect the desired category.

For example, if the end user designates “Sicilian” as the category, the announcements content server may detect a desired category of “pizza,” based on a previously known relationship between the word “Sicilian” and “pizza,” as one type of pizza. These relationships may be known to or pre-registered on the announcements content server. In some embodiments, the announcements content server may also return to the end user a list of possibly matching registered categories, and detect a selection of one of the registered categories by the end user. In these cases, the announcements content server may preserve this selection information, and thereby learn associations of certain words with certain registered categories.

In step 705, the announcements content server detects the relevant announcements that pertain to the category (or categories) received from the end user that are also within the geographic proximity of the end user's designated location. As disclosed earlier, the range of geographic proximity may be set by the end user and transmitted to the announcements content server as part of the request.

Detecting whether a particular announcement is within the appropriate geographic proximity to the end user's designated location may be done by setting the end user's designated location as a ‘center’ to conduct searching, and then detecting the announcements whose addresses or coordinates fall within an appropriate area relative to the center. This appropriate area may be a radius based on the set geographic proximity. However, it is also contemplated that the map display is typically shown as a square or rectangular area. Accordingly, the geographic proximity set by the user may alternatively be used to set a relevant display area, in which all announcements falling within the display area may be retrieved.

In step 710, the detected announcements that correlate to the designated category (or categories) and the appropriate geographic proximity to the end user designated geographic location are transmitted to the end user's terminal for display to the end user.

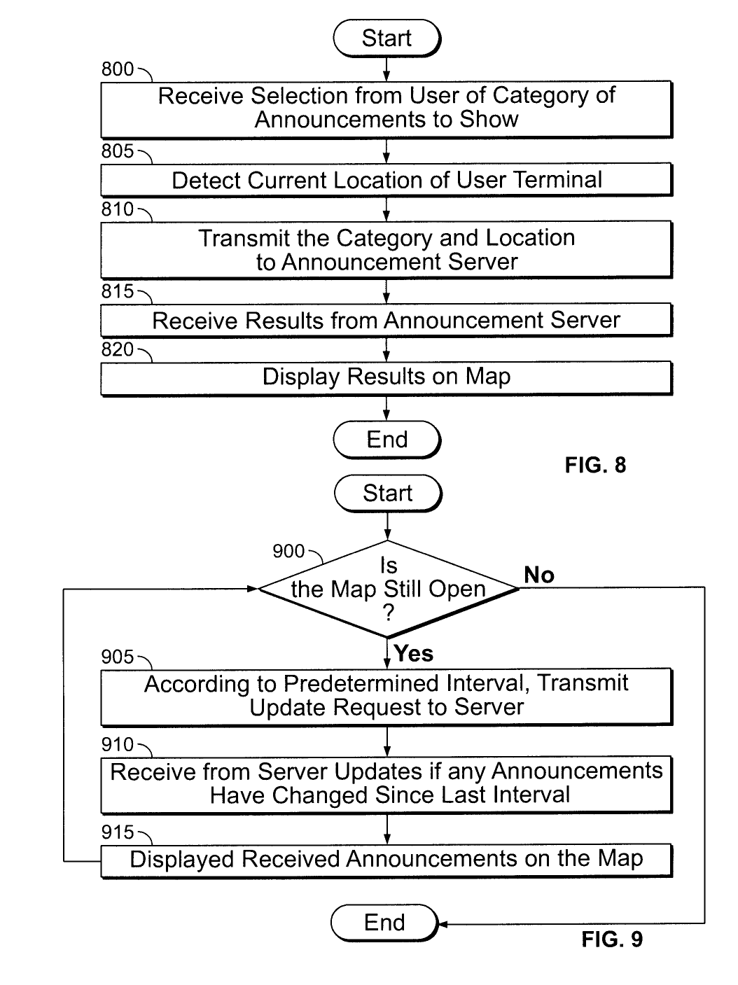

FIG. 8 is a flow chart representing an example sequence of steps for an end user terminal. In step 800, the end user terminal may receive from the end user at least one category of announcements. In one embodiment, the end user may select the category from one of a number of categories visually displayed on a display of the end user terminal (e.g., element 410 of FIG. 4). The end user may also enter a search keyword either related to or directly indicating a search category (e.g., via the search bar 405 of FIG. 4).

In step 805, the end user terminal may retrieve a current location or an end user designated location. The current location may be ascertained by a number of means, including, for example, GPS locating based on a GPS unit installed in the end user terminal. Alternative locating strategies may be utilized. For example, the end user terminal may approximately locate the device using wi-fi locating, if the terminal is connected to a wi-fi network. The end user terminal may also simply receive, from the end user, a manual entry of the present or desired location around which to search for announcements. Any appropriate locating strategy may be utilized.

In step 810, the end user terminal may transmit the end user designated category and geographic location to the announcements content server. This information may be broadcast in a variety of means, such as through an internet connection provided by a base station (e.g., element 115 of FIG. 1), a wireless connection (e.g., element 125 of FIG. 1) or a wired connection (e.g., element 130 of FIG. 1).

In response, in step 815, the end user terminal may receive announcements retrieved by the announcements content server matching the transmitted category and geographic location. If the announcements contained media (such as particular sounds, images or movies), the media may also be received from the announcements content server at this time. Alternatively, if the media is to be displayed on when a particular announcement is selected, opened, expanded or otherwise indicated as to be viewed by the end user, then the media may be downloaded to the user terminal at the time the announcement is selected by the end user. Similarly, certain announcements may be displayed utilizing particular shapes or colors (as disclosed earlier in FIG. 3). Specialized information indicating that certain shapes or colors to be used may also be downloaded at this time.

In step 820, the retrieved announcements may be displayed on a map on a display of the end user terminal. As disclosed earlier (with reference to FIG. 3), when the retrieved announcements are displayed, they may be displayed with any of a plurality of shapes, colors, media, etc. The end user terminal may detect which shape, color, media, etc. to use when displaying each announcement based on information received from the announcements content server. In some embodiments, the end user terminal may also assign shapes, colors or media to each particular announcement. For example, the announcements content server may specify that all deals are to be displayed with a red color. As this may be previously known to the end user terminal, the announcements content server does not need to transmit information indicating that a deal is to be displayed in red with every transmission to an end user terminal. The end user terminal, based on the known information, may automatically assign the relevant color or shape or media based on the category information of the particular announcement. Therefore, all announcements belonging to a common category may thus be displayed in an organized manner, allowing users faster recognition and understanding of the information conveyed. For example, as shown in FIG. 3, standard promotions may be displayed using “word bubble” shapes, and grand-opening promotions may be displayed using “thought bubble” shapes. The designated location may also be shown, using any desired shape or color or media or pattern. For example, in FIG. 3, the designated location may be a current location of the end user terminal, and may be indicated by a “star” shape.

FIG. 9 is a flow chart representing an example sequence of steps for updating the end user display in real-time when a change is made to an announcement. As disclosed earlier, in some circumstances, a publisher user may alter an announcement while one or more end users are viewing the announcement on their respective terminals. In some embodiments, the end user terminal and announcements content server may be configured to automatically update the announcement displayed on the end user's terminal when an update occurs.

In step 900, the end user terminal may detect whether the map screen (including all the relevant announcements) is still open, indicating that the end user is viewing the announcements. If the map is not open, there is no need to update the announcements, and the sequence of steps therefore may end. If the map is open, there is a need to update the announcements, and the sequence of steps may proceed to step 905.

In step 905, the end user terminal may, at regular intervals, transmit an update request to the announcements content server. The update request may query the announcements server as to whether there are any changes to the announcements currently being displayed on the end user terminal. In one alternative embodiment, the announcements content server may instead track the announcements transmitted to each end user terminal, and transmit an update message to the relevant terminals when it detects that an announcement has been changed by a publisher user.

In step 910, if any changes have been detected by the announcements content server, then in step 915, the end user terminal may receive from the announcements content server new information for the particular updated announcement, transmitted from the announcements content server. In step 915, the updated information may finally be displayed on the map on the end user terminal.

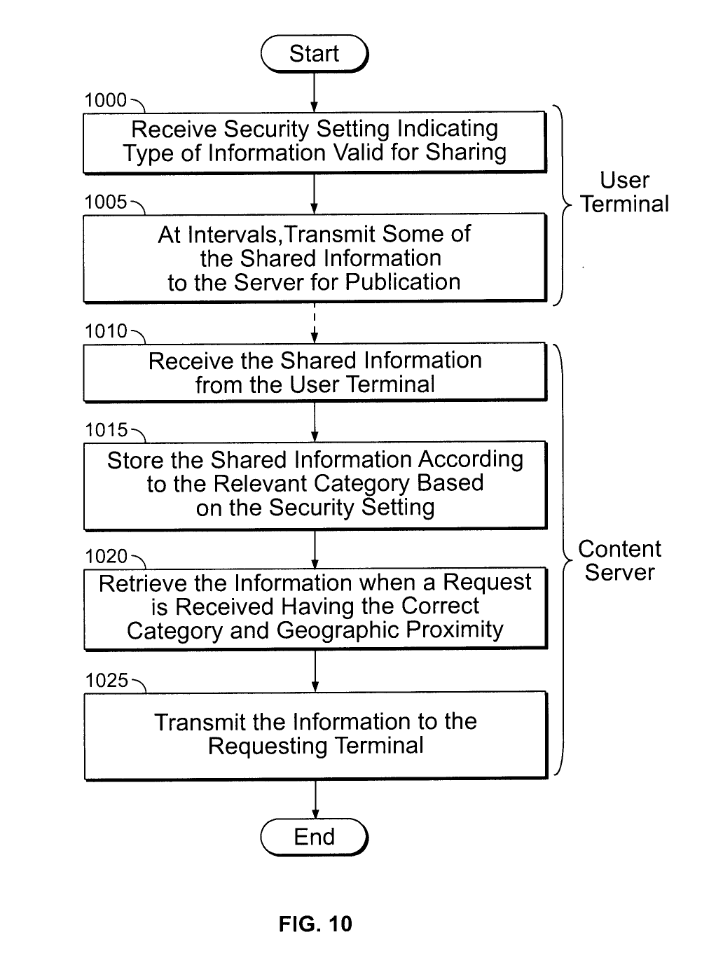

FIG. 10 is a flow-chart illustrating an example sequence of steps for passive publication of announcements (as illustrated, for example, in FIG. 3D). In step 1000, the end user terminal may receive a security setting from the user that dictates the types or forms of information that are valid for sharing via passive announcements. For example, a passive user may have his personal information stored in the announcements content server, such as his name, phone number, sex, address, interests, searched-for categories, etc. The announcements content server may make all, some or none of this information available for passive publication according to the passive user's settings.

In step 1005, the shared information at least a portion of the passive user's shared information may be transmitted to the announcements content server at intervals. Because the announcements content server displays announcements with regard to physical location, at least the physical location may be transmitted to the announcements content server at intervals. For example, the user terminal may be configured to transmit its location to the announcements content server every half hour. Alternatively, the user terminal may be configured to detect its own location, and transmit the location to the announcements content server only if it detects that the present location differs from the last location reported to the announcements content server. Any strategy may thus be used for keeping the announcements content server appraised of the location of the user terminal.

In step 1010, the announcements content server may receive the shared information from the passive user's terminal, which, in step 1015, may then be stored in the relevant category, and associated with the passive user's security setting. For example, if the passive user does not desire their location to be shared in a passive announcement, this information is recorded along with the update of the user terminal location. Therefore, when the announcements content server receives a request for a category the passive user matches, the announcements content server knows to exclude the passive user's information from the announcements transmitted in response to the request, because the passive user indicated that information should remain confidential.

In step 1020, the announcements content server may receive a request for announcements pertaining to at least one category related to passive announcements, and a particular geographic proximity to a requesting user's terminal location. The announcements content server may retrieve passive announcement information matching the at least one category and having a geographic location situated within the particular geographic proximity. If necessary, the announcements content server may aggregate, format, tally, count, compute or otherwise process the accumulated information to generate the appropriate passive announcement for the end user. For example, if the announcement is to indicate a number of singles at a particular location, the announcements content server may count the number end users indicated as single at the location to generate a number for display. In step 1025, the passive announcements are transmitted to the requesting terminal, which displays them on a display for the end user(s).

Having thus described a preferred embodiment for providing a direct venue or announcement platform for small business and individuals, it should apparent to those skilled in the art that certain advantages of the present invention have been achieved. In particular, the present invention provides means for small business owners or individuals to directly advertise via a catchy messages to entice public or consumers without going through a third party agency. For cost sensitive entities or individuals, it can even eliminate the any cost associated with running a website or cost associated with making flyers or hiring staffs for promotions. As most people's activities evolve around their local region, the teaching of the present invention can directly provide most relevant information to the end users without being bombarded with immaterial information by enabling the announcement to be directly controlled by the host or source. The announcements and messages according to the present invention provides means for modify or update in real time by the host or source which are not typically available with the traditional advertising scheme. Hence, the cost associated with the third party vendor(s) for the advisement or announcement can be saved. The community based platform provided by the teachings of the present invention further provides businesses to compete and reach out to consumers in a creative and flexible way that was not possible under the traditional advertising model. By enticing consumers with a short messages, business can benefit from additional sales generated after enticing the consumers to their doors. Moreover, individuals can enhance their recreational or entertainment experiences. For example, if a user wishes to play a pickup basketball, the user can see others in the community based platform who are available for the pickup game in various parks or school location nearby their home so that the user can quickly participate the activity without waiting for others to show up in a given location. That is, the present invention further provides a non-commercial application for public to congregate and/or share information. For example, parents in the same neighbors can set up a play date for their kids using the community based platform according to the present invention. Further, a number of religious groups can post their messages indicating a meeting or special event using the present invention.

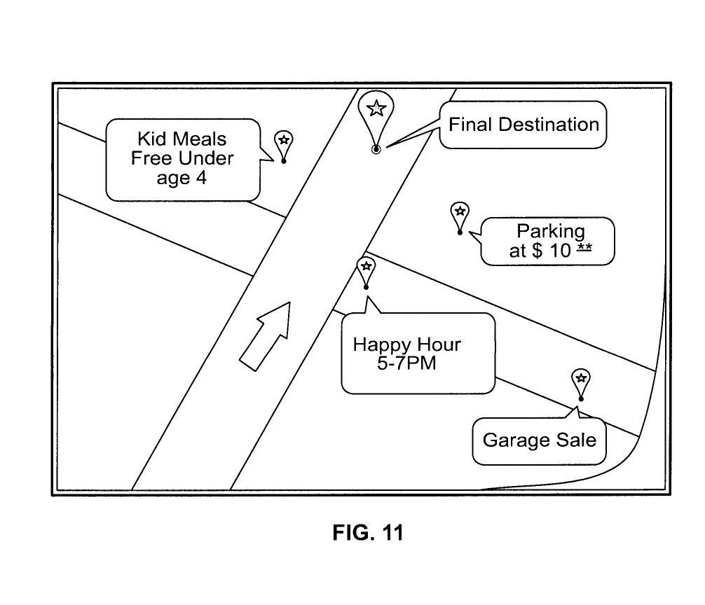

In an alternate embodiment, the teachings of the present invention can be applied to a GPS system or a portable mobile device such that if a user inputs a desired destination, the announcements and/or messages posted by nearby venue or business entities can be displayed in the GPS system in their vehicles or mobile devices as shown in FIG. 11. As shown, a driver or person nears a final destination, a number of announcements and/or messages can be displayed as he or she approaches the final destination. To this end, the host of the announcements and/or message has to relate their respective messages to the final destination or a certain vicinity around the final destination. This way, hosts or vendors can target the traffic destined to a particular location. For example, if users put a specific museum or a sports game as a final destination, the host of announcements and/or messages can tied their messages to the popular destination like the museum or a sports game to advertise their respective messages to the incoming traffic. To achieve this, a user has access a remote server according to the teaching of invention or utilize a conventional GPS application where inputs by various host entities can upload or update their respective announcements and/or messages as explained in this specification.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. An electronic device comprising:
at least one processor configured to:
receive a request to display specific announcement data associated with a specific interest at a given location within a particular geographical radius; and
in response to the request, display an event map corresponding to the particular geographical radius with the announcement data associated with the specific interest at the given location, the announcement data is directly inputted by a user associated with at least one source using another electronic device so that the announcement data is updated at any desired time

2. The electronic device of claim 1, wherein the at least one processor is further configured to display the announcement data in a particular color indicative of a type of event or sale.

3. The electronic device of claim 1, wherein the at least one processor is further configured to display the announcement data in a text box of a particular shape indicative of a type of event or sale.

4. The electronic device of claim 1, wherein the announcement data comprises at least one of a text, a video, and a picture.

5. The electronic device of claim 1, wherein the at least one processor is further configured to detect an update to the announcement data and display the updated announcement data at the given location on the map.

6. The electronic device of claim 1, wherein the at least one processor is further configured to filter the announcement data displayed on the map in accordance with a profile filter.

7. The electronic device of claim 1, wherein the request comprises a voice command.

8. A method comprising:
receiving a request to display specific announcement data associated with a specific interest at a given location within a particular geographical radius; and
displaying a map corresponding to the particular geographical radius such that the announcement data associated with the given location, wherein the announcement data is directly inputted by a user associated with at least one source using another electronic device so that the announcement data is updated at any desired time.

9. The method of claim 8, further comprising displaying the announcement data in a particular color indicative of a type of event or sale.

10. The method of claim 8, further comprising displaying the announcement data in a text box of a particular shape indicative of a type of event or sale.

11. The method of claim 8, wherein the announcement data comprises at least one of a text, a video, and a picture.

12. The method of claim 8, further comprising detecting an update to the announcement data and display the updated announcement data at the given location on the map.

13. The method of claim 8, further comprising filtering the announcement data displayed on the map in accordance with a profile filter.

14. A non-transitory computer readable medium having instructions stored therein which upon execution instruct at least one processor to:
receive a request to display specific announcement data associated with a specific interest on a map corresponding to a given location within a particular geographical radius; and
display the map such that the announcement data associated with the specific interest at the given location within the map is displayed concurrently, wherein the announcement data is directly inputted by a user associated with at least one source using another electronic device so that the announcement data is updated at any desired time.

15. The non-transitory computer readable medium of claim 14, wherein the instructions stored therein further instruct the at least one processor to display the announcement data in a particular color indicative of a type of event or sale.

16. The non-transitory computer readable medium of claim 14, wherein the instructions stored therein further instruct the at least one processor to display the announcement data in a text box of a particular shape indicative of a type of event or sale.

17. The non-transitory computer readable medium of claim 14, wherein the announcement data comprises at least one of a text, a video, and a picture.

18. The non-transitory computer readable medium of claim 14, wherein the instructions stored therein further instruct the at least one processor to detect an update to the announcement data and display the updated announcement data at the location within the given location.

19. The non-transitory computer readable medium of claim 14, wherein the instructions stored therein further instruct the at least one processor to filter the announcement data displayed on the map in accordance with a profile filter.

20. The non-transitory computer readable medium of claim 14, wherein the request is a voice command.
receive a request to display specific announcement data at a given location within a particular geographical radius; and

[symbol]

21. A method comprising:
receiving by a processor an input of announcement data and a location, the announcement data and the location associated with a user account;
associating the announcement data with at least one category of the user account; and
transmitting by a network the announcement data and the location to an announcements content server, the announcement data is directly inputted by a user associated with at least one source using another electronic device so that the announcement data is updated at any desired time,
wherein the announcements content server is configured to receive via the network an announcement request including at least a particular category, a particular location and a designated geographic proximity, and transmit the announcement data to an electronic device for display when the at least one category matches the particular category and the location is situated within the designated geographic proximity of the particular location.

22. The method of claim 21, further comprising receiving by the processor a selection of a duration indicating at least a start time and end time for publication of the announcement data,
wherein the announcements content server is further configured to transmit the announcement data in response to the announcement request when a current time is at or after the start time and before the end time.

23. The method of claim 21, wherein receiving the input of announcement data comprises:
when the announcement data includes at least one of an image, a sound or a video, detecting selection of a media file for upload to the announcements content server; and
when the announcement data includes at least text, receiving text input via at least a physical keypad or an on-screen keypad.

24. The method of claim 21, wherein receiving the input of the location comprises at least one of:
detecting selection of the location from a list of locations previously associated with the user account; and
receiving input of an address of the location from at least a physical keypad or an on-screen keypad,
wherein the list of locations comprises at least one of a fixed location and a mobile location.

25. The method of claim 21, further comprising receiving an selection of an additional category that is not associated with the user account, and associating the announcement data with the additional category,
wherein the announcements content server is further configured to transmit the announcement data when the additional category matches the particular category.

26. An electronic device, comprising:
a storage medium;
a transceiver to communicate over a network; and
a processor configured to:
receive an input of announcement data and a location, the announcement data and the location associated with a user account,
associate the announcement data with at least one category of the user account, and
transmit by the transceiver the announcement data and the location to an announcements content server, the announcement data is directly inputted by a user associated with at least one source using another electronic device so that the announcement data is updated at any desired time, wherein the announcements content server is configured to receive via the network an announcement request including at least a particular category, a particular location and a designated geographic proximity, and transmit via the network the announcement data when the at least one category matches the particular category and the location is situated within the designated geographic proximity of the particular location.

27. The electronic device of claim 26, the processor further configured to receive by the processor a selection of a duration indicating at least a start time and end time for publication of the announcement data,
wherein the announcements content server is further configured to transmit the announcement data in response to the announcement request when a current time is at or after the start time and before the end time.

28. The electronic device of claim 26, wherein receiving the input of announcement media comprises:
when the announcement data includes at least one of an image, a sound or a video, detecting selection of a media file for upload to the announcements content server; and
when the announcement data includes at least text, receiving text input via at least a physical keypad or an on-screen keypad.

29. The electronic device of claim 26, wherein receiving the input of the location comprises at least one of:
detecting a selection of the location from a list of locations previously associated with the user account; and
receiving input of an address of the location from at least a physical keypad or an on-screen keypad,
wherein the list of locations comprises at least one of a fixed location and a mobile location.

30. The electronic device of claim 26, further comprising receiving an input of an additional category that is not associated with the user account, and associating the announcement data with the additional category in response to the input.

31. A system, comprising:
a storage unit for storing announcement data;
a network interface for communicating over a network; and
a processor configured to:
receive from an electronic device at least an announcement data and a location, the announcement data and location associated with a user account,
associate the received announcement data with at least one pre-associated category of the user account,
receive a request from a requesting terminal for announcements related to at least one specified category, within a geographic proximity of a specified location, and
transmitting the announcement data to the requesting terminal when the at least one specified category matches the pre-associated category, and the location is within the geographic proximity of the specified location, wherein the announcement data is directly inputted by a user associated with at least one source using another electronic device so that the announcement data is updated at any desired time.

32. The system of claim 31, wherein the processor is further configured to:
receive from the electronic device a duration indicating at least a start time and end time for publication of the announcement data;
detect a current time and transmit the announcement data in response to the request when a current time is at or after the start time and before the end time.

33. The system of claim 31, wherein the processor is further configured to:
receiving from the electronic device a particular category that is not pre-associated with the user account,
associate the particular category with the announcement data, and
transmit the announcement data to the requesting terminal when the particular category matches the pre-associated category and the location is within the geographic proximity of the specified location.

34. The system of claim 31, wherein the processor is further configured to:
in response to the request from the requesting terminal, retrieve end user information indicated as publicly available within an end user account, the end user information including at least a last-known location of a terminal of the end user account,
when the last-known location of each terminal is within the geographic proximity of the specified location, include the end user information in a calculation, processing the end user information into at least one passive announcement, and
transmitting the at least one passive announcement to the user terminal.

35. The system of claim 34, wherein processing the end user information comprises:
aggregating end user information indicated as publicly available from a plurality of user accounts; and
performing at least one computation on the aggregated end user information to generate the passive announcement.

36. An electronic device comprising:
at least one processor configured to:
transmit a request to display a guideline to reach a particular destination;
in response to the request, display a map corresponding to the particular destination and display announcement data associated with the particular destination, wherein the announcement data is directly inputted by a user associated with at least one source using another electronic device so that the announcement data is updated at any desired time

[symbol]

37. A method comprising:
receiving an input of announcement data and a particular location, the announcement data and the particular location associated with a user account;
associating the announcement data with the particular destination, the announcement data is directly inputted by a user associated with at least one source using another electronic device so that the announcement data is updated at any desired time; and
in response to a request to display a guideline to reach the particular location, transmit the announcement data to a recipient of the request for display so that the announcement data is displayed as the recipient nears the particular destination.
